(19) United States
(12) Patent Application Publication
(10) Pub. No.: US 2013/0220131 A1
(43) Pub. Date: Aug. 29, 2013

(54) Novel System for Adsorbing and Separating Suspended Gaseous Impurities from Effluent Gases and Thereby Recovery of Value Added Products

(71) Applicant: Dhananjay Digambar Pande, Mumbai (IN)

(72) Inventor: Dhananjay Digambar Pande, Mumbai (IN)

(21) Appl. No.: 13/884,134

(22) PCT Filed: Apr. 8, 2011
(86) PCT No.: PCT/IN11/00244

§ 371 Date: May 8, 2013

(30) Foreign Application Priority Data
Nov. 9, 2010 (IN) 3083/MUM/2010

(51) Int. Cl. B01D 53/14

(52) U.S. Cl. CPC B01D 53/1406
USPC 96/371

(57) ABSTRACT

An apparatus comprising four compartments connected by inlet and outlet valves in tandem. Effluent gases from a high temperature reactor pass through a filtration unit and are directed through the inlet of a first chamber through a perforated pipe placed at the bottom of the chamber. The hot flue gas then flows upward through the liquid/slurry contained in the chambers, such that the carbonaceous impurities are absorbed in the liquid/slurry along with the temperature of the flue gas in stages so as to obtain oxygen without impurities through at least one discharge. Each chamber is provided with a temperature indicating unit, a stirrer unit, inlet and outlet valves, and a discharge unit at the bottom of the chamber.

The invention relates to separation of gaseous impurities from effluent gases discharge from reactors, carbon monoxide, dioxide generated in the thermal power station and coal base reactor and to obtain oxygen saturated environment friendly gases.

Then conventional devices and the method of obtaining clean gases so far has not found satisfactory. Therefore, there is need to develop a system and a methodology to separate these unwanted impurities from the gaseous stream and to obtain oxygen saturated environment friendly gases. During the conversion process, many bi-products are recovered which can be further process for value added products for the industry at large.

The CO₂ emission is a world concern for the global warming which is dangerous for the mankind. Globally, there are different measures are being taken for reducing global warming. Atmosphere gases containing a mixture of nitrogen, oxygen, organ carbon, and while this gases are burned for the purpose of production lots of carbonous material along with other gases oxides of many radicals are generated which are required to be remove to obtain clear oxygen for use.

The primary objects of this invention is therefore to separate the gaseous impurities such as CO₂, SO₂, NO₂, HCl and higher molecular hydro carbon, toxic gases and the like containing effluent gases in the reactor and to obtain oxygen saturated environment friendly gases.

Still further object of this invention is to separate bi-products which can be process further for value added products.

Further object of this invention is to perform the invention without much costs and manpower.

Accordingly there is provided an apparatus containing four chambers connected by inlet and outlet valves in tandom;

the effluent gases from the high temperature reactor passes through the first chamber through a mesh of a specific size to remove the unburned solid particles in the gas stream; the gases stream from first chamber enters into the second chamber through the outlet of chamber one and passes through the liquid containing in the second chamber which are mainly liquid/slurry to absorb the heat of the effluent gases and to absorb soluble gases;

the cooled gaseous mixture enters in the third chamber containing mixture of liquid/slurry to absorb/adsorb the carbonous gases;

the effluent gases from the third chambers enters the fourth chambers containing liquid/slurry to absorb/adsorb gases like Sulfur, NOX, Mercury etc. and Oxygen saturated environment friendly gases are obtained through the outlet of fourth chamber.

The first chamber containing the mesh having a size from 5 to 15 micron made of steel.

Second chamber containing slurry selected from the following groups:
i) Cow dung mixed with seawater.
ii) Cow dung mixed with seawater and neem extract.
iii) Cow dung mixed with seawater and cow urine.
iv) Cow dung mixed with water and cow urine.
v) Cattle dung mixed with sea water and cattle urine.
vi) Cow dung mixed with water.
vii) Cattle dung mixed with neem extract, water and plant extract.
viii) Cattle dung mixed with sea water.
ix) Cattle dung mixed with water.

The third chambers containing liquid/slurry are selected from the following groups:
i) Crude bio-diesel, bio-diesel/bio-oil.
ii) Crude bio-diesel, bio-diesel, bio-oil along with chemicals extracted from the plants which are derived from the plants which are classified as petro plants.
iii) Cow dung mixed with cow urine and water.
iv) Diesel mixed with crude oil and Greece and/or oil.

The fourth chambers containing liquid/slurry are selected form the following combinations:
i) Slurry of lime and sea water
ii) Slurry of sodium bi-carbonate, seawater and lime.

iii) Slurry of water and lime slurry
iv) Slurry of sodium bi-carbonate, seawater and lime.
v) Slurry se water mixed with cow urine+lime+sodium carbonate
vi) Cow urine mixed with water and sodium chloride
vii) Cow urine mixed with sea water.

The second chamber containing cow/cattle dung and sea water mixture which reduces the temperature of the effluent gases, due to the property of cow dung, which contain methane, nitrogen etc. And seawater absorbs the soluble gases such as CO₂, SO₂, NO₂, Hcl and the like.

The third compartment contains crude bio diesel and bio oil and chemical extract from the plants such as petro plant. The mixture is viscose in nature and capable of absorbing/adsorbing high molecular weight poly nuclear, hydrocarbon. The apparatus of this invention is capable of removing both particulate and noxious components from the effluent stream generated after burning solid or liquid fuel. It is particularly suited for taping the above pollutant and at the same time generating value added products like carbon powder or carbon black or carbon saturated semiliquid, which find wide industrial applications.

The fourth compartment containing slurry of lime and sea water/water, Sodium bi carbonate capable of in taping CO₂, SO₂, NO₂, Hcl.

Sulfur dioxide is absorbed in lime slurry and then precipitated with calcium sulfite, which can be converted gypsum as a saleable bi-products. Lime also reacts radically with other gases such as Hcl.

Considering fuel with high level of mercury emission, hydrated lime with activate carbon are effectively combined for the removal of SO₂ mercury.

While considering fuel with low sulfur percentage seawater mixed with sodium bi carbonate with lime which produces desired level of removal of SO₂ of absorption of other gases.

The value added products generated during the process such as saturated slurry/liquid from the second tank. Once dried up can be used as fuel for domestic as well as industrial use.

The products generated in the third chamber saturated products as option such as a semi liquid or in cake form which can be used for road construction which is a natural bio bitumen or cake or further processed to powder form, which can be used for various industrial application.

Due to binding property of the use slurry in the fourth compartment the bio products can be used for construction.

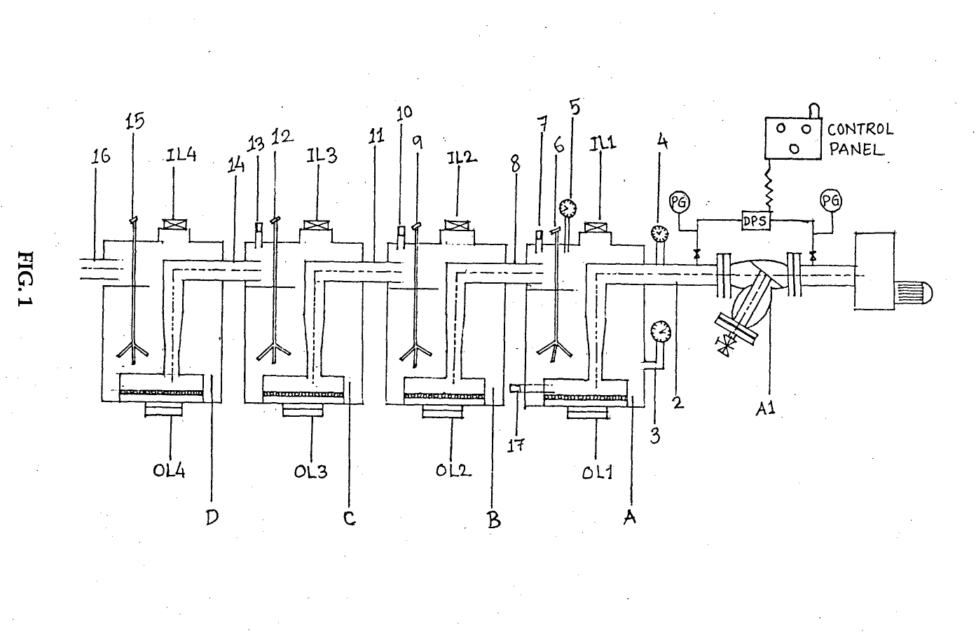

The invention will now be described with reference to FIGS. 1 to 3 accompanying drawings:

FIG. 1 is a perspective view of the apparatus with four chambers

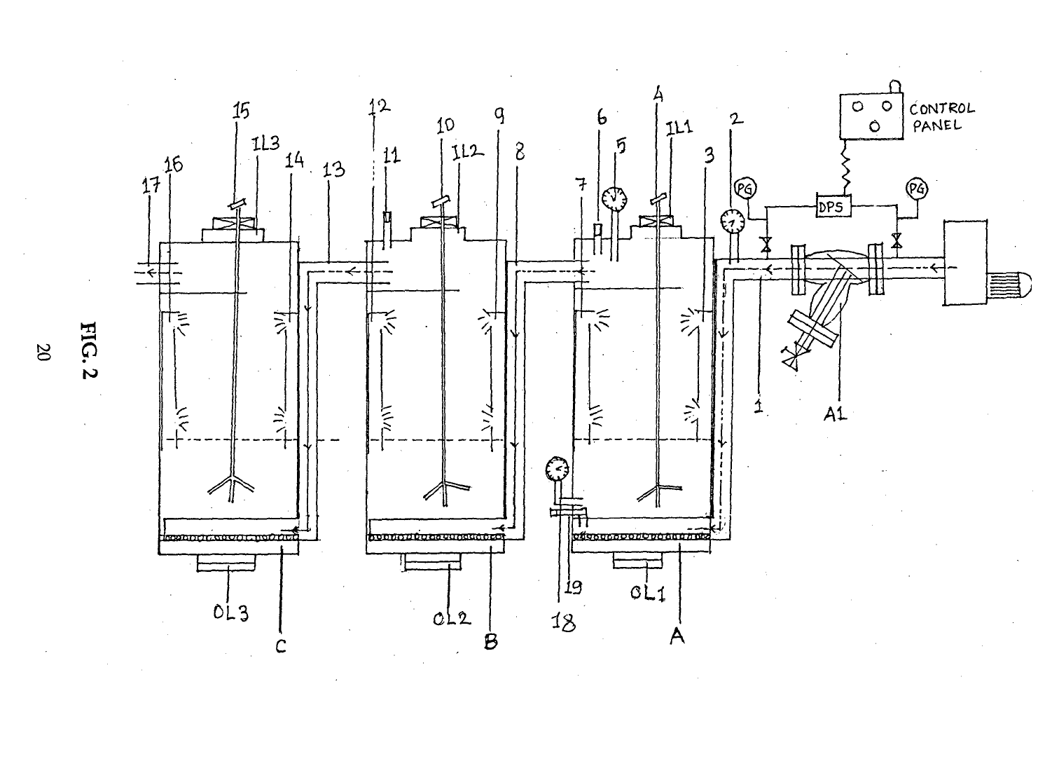

FIG. 2 is a perspective view of the apparatus with three chambers

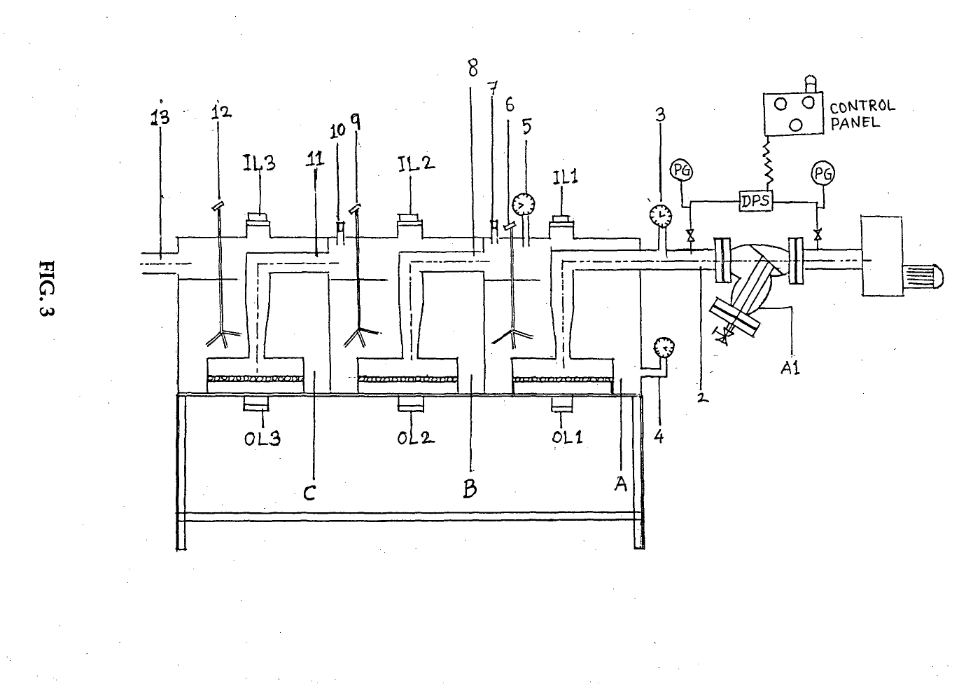

FIG. 3 is a perspective view of the apparatus with three chambers.

With reference to FIGS. 1 to 3, the apparatus comprising of four compartments, connected by inlet and outlet valves in tandom; the effluent gases from the high temperature reactor passes through the first chamber through a mesh of a specific size to remove the unburned solid particles in the gas stream; the gases stream from first chamber enters into the second chamber through the outlet of chamber one and passes through the liquid containing in the second chamber which are mainly slurry to absorb the heat of the effluent gases and to absorb soluble gases; the cooled gaseous mixture enters in the third chamber containing mixture of liquid/slurry to absorb the carbonous gases; the effluent gases from the third chambers enters the fourth chambers containing liquid/slurry to absorb gases like sulfur, Nox mercury etc. and oxygen saturated environment friendly gases are obtained through the outlet of fourth chamber.

FIG. 1 The hot effluent gas enters the filtration section A1 and passes through the duct into inlet (2) for flu gas in chamber A; the hot flu gas is directed through the perforated pipe at the bottom of the chamber A containing liquid to separate the CO2, SO2 and other carbonous material from the hot flu gas. The chamber A is also provided with temperature indicated (3,4,5) for measuring the temperature of the hot flu gas; there is provided is starrer (6) for stirring the liquid in the chamber A; there is provided with inlet and outlet valves IL1 and OA1 for pouring the fresh liquid in the chamber by discharging the saturated liquid from the bottom of chamber A. There is provided means for spurging oxygen (17) from the outside at the bottom of the liquid in chamber A. There is further provided with sample point (7) for gases in chamber A. The hot flu gas emerges through the liquid and then passes to the inlet valves (8) of chamber B Where flu gas is directed through the perforated pipe situated at the bottom of the chamber B. The flu gas trouble upward through the liquid/slurry contains in chamber B to absorb carbonous gases such as Co2, Co, No2, So2, HC; the chamber is further provided with a starrer (9) and inlet and outlet discharge valve IL2 and OL2 the cool flu gases enter the chamber 3 through the inlet (11) the chamber C containing liquid/slurry to absorb the remaining soluble impurities such as Co2, Co, No2, So2, HC and then enters in the fourth chamber D in a similar manner to obtain oxygen without any impurities through the discharge (16) which can be collected for further use. The chamber C and a Chamber D is also provided with starter (12), (15) inlet and outlet valves IL3 IL4 and OL3 and OL4. The chamber B and C also provided with sampling point (10 and 13) to analysis to content of the gases during the separation process.

With reference to the FIG. 2. The hot reactor gas are entered through A1-filtration system with control panel which passes through inlet for flu gas (1) which are passes through the duct into the chamber A where it passes through temperature gauge (2) for gases flowing through high temperature reactor and said gas is pass through a perforated tubes placed at the bottom of the chamber A filled with liquid as herein described and then gases travel upward through the chamber A which is provided with multiple of sprays (3) at the side of wall to reduce the heat of flue gases. So as to absorbed the impurities contain in the flu gas. The chamber A is provided with a starrer (4) to stair the liquid during the operation. There is inlet and outlet valves (IL1 and OL1) in the chamber A; as and when the liquid becomes saturated the refilling of the liquid and discharging of the liquid carried out through the inlet and outlet valves. There is temperature gauges (18) provided for the incoming liquid in the chamber (A). There is provide with a oxygen inlet valve (19) to inlet oxygen to convert un burn Co to CO2; there are another temperature outlet gauge (5) for measurement of temperature for the gases coming out of the chamber A and going into the chamber B. The chamber A is further provided with a sample gas point (6) for chamber A. The gases flowing into the chamber B through the ducting or ducting inlet (8) through the bottom of the chamber B through perforated pipes into the chamber B containing liquid/slurry having similar construction like chamber A such as spray (9 and 12) nozzle inlet and outlet valves (IL2 and OL2) sampling units (11). The cool gases passes through chamber B entered into the chamber C through the inlet valve 13 via a downwardly directed ducting which connected to perforated pipes provided the bottom of the chamber C, the gases passes upward through the perforation through the liquid and slurry contains into the chamber C and travel which also provided with inlet valves IL3 and outlet valves OL3 and the discharged valves (17). Both the chamber B and C also provided with starrer 10 and 15 as it is provided in chamber A.

With reference to FIG. 3, the hot flu reactor gas passes through the filtration unit A1 for removing solid particles if any and then hot gas is directed through the inlet 2 and passes through the ducting directed at the bottom of the chamber A and passes through the perforated pipe so that the hot gas is made to travel upward through the liquid contain in the chamber A. So that the liquid absorbs carbonous substances and dissolves in the liquid containing in the chamber A. Also the temperature of the flu gas is also absorbed by the liquid present in the chamber A. The liquid passes through the inlet (8) of chamber B and directed similar manner through the chamber B containing the liquid slurry where the gases such as Co2, Co, No2, So2, HC will be absorb. The cool flu gas is now directed to chamber C through the inlet (11) and passes through the liquid/slurry contain in Chamber C and thereby oxygen without impurities is discharge at 13 which will be subsequently collected for further use. The chamber A, B and C are provide with temperature indicated (3,4,5) and sampling point at Chamber A and B (7,10). Each chamber is provide with starrer (6,9,12) the chamber are also provided in inlet valve (IL1, IL2, IL3) and outlet valves (OL1, OL2, OL3).

These are the embodiment of the invention several modification are possible, which may be considered within the ambit spirit of this invention.

### EXAMPLES

### Trial 1

It is observed that the gases flowing from furnace/high temperature reactor to Tank A and then exiting from there to Tank B the temperature of the gases significantly reduced to the room temperature.

### Fuel: Raw Coal

While performing 1^{st} trial with 50 kgs of RAW COAL were burnt in the furnace.

| GASES | FURNACE | TANK A | TANK B | TANK C |
|---|---|---|---|---|
| O2 | 04.1% | 13.2% | 15.2% | 16.3% |
| CO2 | 010.3% | 006.0% | 001.0% | NIL |
| CO | 1998 PPM | 1254 PPM | 1254 PPM | 1254 PPM |
| NO2 | 0000 PPM | 0000 PPM | 0000 PPM | 0000 PPM |
| SO2 | 1545 PPM | 0140 PPM | 0140 PPM | 0140 PPM |
| HC | 000.0% | 000.0% | 000.0% | 000.0% |

| | |
|---|---|
| VOLUME | CONTENTS |

| | | | |
|---|---|---|---|
| TANK A | 20 | ltrs | water |
| | 2 | kg | Cow dung |
| | ½ | ltr | Cow urine |
| TANK B | 20 | ltrs | Bio Diesel |
| TANK C | 20 | ltr | Seawater |
| | ½ | kg | Lime |

### Observation/Result

1) O2: While performing 1^{st} trial it was observed that the gas sample taken from furnace 02 was 4.1%, while the sample taken from Tank A when the gases are passed through the slurry of water, cow dung and cow urine the % of O2 is increased from 4.1% to 13.2%. While the cool gases were flowing through the content of Tank B and the sample taken after gases exiting through the content of Tank B, that is bio diesel, the % of O2 further increased to 15%. Further the gases, which were flowing from Tank B to Tank C through the contents of Tank C that is the mixture of seawater and lime, the sample taken was observed that the % of O2 further increased to 16.8%.
2) CO2: While performing 1^{st} trial it was observed that the sample taken from furnace, CO2 was 10.3%, while the sample taken from Tank A when the gases exited through the slurry of water, cow dung and cow urine the % of CO2 is decreased from 10.3% to 06.0% while cool gases flowing through Tank B containing bio diesel, the sample taken and observed that the % of CO2 further decreased to 1.0%. Further the gases, which were flowing from Tank B to Tank C after passing through the contents of Tank C that is the mixture of seawater and lime, the sample taken was observed that the % of CO2 further decreased and it was nil.
3) CO: While performing 1^{st} trial it was observed that the sample taken from furnace CO was 1998 PPM, while the sample taken from Tank A when the gases exited through the slurry of water, cow dung and cow urine the % of CO is decreased from 1998 PPM to 1254 PPM while cool gases flowing through the content of Tank B that is bio diesel and the % of CO was same. Further the gases, which were flowing from Tank B to Tank C after passing through the contents of Tank C that is the mixture of seawater and lime, the sample taken and was observed that the % of CO still remained the same.
4) SO2: While performing 1^{st} trial it was observed that the sample taken from furnace SO2 was 1545 PPM, while the sample taken from Tank A when the gases exited through the slurry of water, cow dung and cow urine the % of SO2 is decreased from 1545 to 0140 while cool gases flowing through the content of Tank B and sample taken after gases exiting through the content of Tank B, that is bio diesel the % of SO2 was same. Further the gases, which were flowing from Tank B to Tank C after passing through the contents of Tank C that is the mixture of seawater and lime, the sample taken was observed that the % of SO2 still remained the same.

### EXAMPLE

### Trial 2

### Fuel: Raw Coal

It is observed that the gases flowing from furnace/high temperature reactor to Tank A and then exiting from there to Tank B the temperature of the gases significantly reduced to the room temperature.

While performing the 2^{nd} trial with 50 kgs of RAW COAL were burnt in the Furness.

| GASES | FURNACE | TANK A | TANK B | TANK C |
|---|---|---|---|---|
| O2 | 02.0% | | | 19.0% |
| CO2 | 017.1% | | | 001.7% |
| CO | 1998 PPM | | | 1326 PPM |
| NO2 | 0000 PPM | | | 0000 PPM |
| SO2 | 0672 PPM | | | 0069 PPM |
| HC | 000.0% | | | 000.0% |

| | |
|---|---|
| VOLUME | CONTENTS |

| | | | |
|---|---|---|---|
| TANK A | 20 | Ltrs | Sea Water |
| | 2 | Ltrs | Cow urine |
| TANK B | 20 | Ltrs | Water |
| | 2 | Kg | Cow dung |
| | 2 | Ltrs | Cow urine |
| TANK C | 20 | ltrs | Seawater |
| | 2 | Kg | Lime and soda bi- |
| | | | carbonate |
| | 2 | Ltrs | Cow urine |

### Observation/Result

1) O2: While performing 3^{rd} trial it was observed that the gas sample taken from furnace O2 was 02.0%, while the sample taken from Tank A when the gases are passed through the slurry of sea water, cow dung and cow urine the % of O2 is increased from 02.0% to 19.0%. While the cool gases were flowing through the content of Tank B and the sample taken after gases exiting through the content of Tank B, that is water, cow dung and cow urine, the % of O2 further increased to 19.0%. Further the gases, which were flowing from Tank B to Tank C through the contents of Tank C that is the mixture of seawater, cow urine, lime and soda bicarbonate the sample taken was observed that the % of O2 further increased to 19.0%.
CO2: While performing 3^{rd} trial it was observed that the gas sample taken from furnace CO2 was 017.1%, while the gases are passed through the Tank A, B and C the % of CO2 is decreased from 017.1% to 001.7%.
3) CO: While performing 3^{rd} trial it was observed that the gas sample taken from furnace CO was 1998 PPM while the gases are passed through the Tank A, B and C the % of CO is further decreased from 1998 PPM to 1326 PPM.
4) SO2: While performing 3^{rd} trial it was observed that the gas sample taken from furnace SO2 was 0672 PPM while the gases are passed through the Tank A, B and C the % of SO2 is further decreased from 0672 PPM to 0069 PPM.

### EXAMPLE

### Trial 3

### Fuel: Raw Coal

It is observed that the gases flowing from furnace/high temperature reactor to Tank A and then exiting from there to Tank B the temperature of the gases significantly reduced to the room temperature.

While performing the 3^{rd} trial with 50 kgs of RAW COAL were burnt in the furnace.

| GASES | FURNACE | TANK A | TANK B | TANK C |
|---|---|---|---|---|
| O2 | 00.5% | | | 20.4% |
| CO2 | 015.3% | | | 000.8% |
| CO | 1998 PPM | | | 0000 PPM |
| NO2 | 0000 PPM | | | 0000 PPM |
| SO2 | 1008 PPM | | | 000.0% |
| HC | 020.7% | | | 000.0 |

| | |
|---|---|
| VOLUME | CONTENTS |

| | | | |
|---|---|---|---|
| TANK A | 20 | ltrs | Sea water |
| | 2 | kg | Cow dung |
| | ½ | ltr | Cow urine |
| TANK B | | | Bio diesel |
| | | | Crude bio diesel |
| TANK C | 20 | ltrs | Seawater |
| | 2 | kg | Lime |
| | 2 | ltrs | Cow urine |

### Observation/Result

1) O2: While performing 5^{th} trial it was observed that the gas sample taken from furnace O2 was 00.5%, while the sample taken from Tank C containing seawater, lime and cow urine. After the gases passed through the slurry of seawater, cow dung and cow urine present in the Tank A then passing through Tank B contents containing Bio diesel and crude bio diesel and then gas passing through Tank C the % of O2 is increased from 00.5% to 20.4%.
2) CO2: While performing 5^{th} trial it was observed that the gas sample take from furnace CO2 was 015.3%, while the sample taken from the last Tank, Tank C containing seawater, lime, and cow urine. After the gases passed through the slurry of seawater, cow dung and cow urine present in the Tank A then passing through Tank B contents containing. Bio diesel and Crude bio diesel and then the gas passing through Tank C the % of CO2 is decreased from 015.3% to 000.8%.
3) CO: While performing 5^{th} trial it was observed that the gas sample taken from furnace CO was 1998 PPM and then it decreased to 0043 PPM after passing through Tank A, B and C.
4) NO2: While performing 5^{th} trial it was observed that the gas sample taken from furnace NO2 was 000.0% so there was no changes in the sample.
5) SO2: While performing 5^{th} trial it was observed that the gas sample taken from furnace SO2 was 1008 PPM, while the sample taken from Tank C containing seawater, lime and cow urine. After the gases passed are through the slurry of seawater, cow dung and cow urine present in the Tank A then passing through the Tank B containing Bio diesel and Crude bio diesel and then gas passing through Tank C the % of SO2 is decreased from 1008 PPM to 0000 PPM.
6) HC: While performing 5^{th} trial it was observed that the gas sample taken from furnace, HC was 020.7% decreased to 0000.0% after passing through the contents of Tank A, B and C

1. An apparatus comprising four chambers connected by inlet and outlet valves in tandom, wherein the effluent gases from a high temperature reactor pass through a filtration unit and are directed through an inlet of a first chamber through a perforated pipe placed at the bottom of the chamber, hot effluent gas flows upward through a liquid/slurry contained in the chambers, such that carbonous impurities are absorbed in the liquid/slurry along with a temperature of the effluent gas in stages so as to obtain oxygen without impurities through at least one discharge and each chamber is provided with a temperature indicating unit, a stirrer unit, inlet and outlet valves, and a discharge unit at the bottom of the chamber.

2. An apparatus comprising four chambers, wherein a first chamber has a mesh of a specific size to remove unburned solid particles in a gas stream, the effluent gas stream from the first chamber enters into a second chamber through an outlet of the first chamber and passes through liquid contained in the second chamber which is mainly slurry to absorb heat from the effluent gases and to absorb soluble gases resulting in a cooled gaseous mixture, the cooled gaseous mixture enters a third chamber containing a mixture of liquid/slurry to absorb carbonous gases, and effluent gases from the third chamber enter a fourth chamber containing liquid/slurry to absorb gases, such that oxygen saturated environmentally friendly gases are obtained through an outlet of the fourth chamber.

3. A method for treating hot gaseous effluent from high temperature reactors to remove impurities from gases comprising the following steps:
i) removing bigger size particles in a compartment by passing the effluent through a mesh of specific size;
ii) passing the hot effluent gases through a mixture of slurry to remove soluble gases as well as impurities;
iii) passing cool effluent gases from step ii through a liquid in a third compartment containing a combination of crude bio-diesel or bio-oil along with chemical extract from petro plants; and
iv) passing effluent gas from step iii through a fourth compartment containing a mixture of a slurry of lime and sea water for entrapping
CO₂, NO₂, SO₂, HCl to obtain pure oxygen emitted through to an outlet of the fourth compartment.

4. A device for purifying gaseous effluent from high temperature reactors comprising of four compartments in tandom having an inlet valve wall and an outlet valve along with a stopper and a level gauge wherein the compartments are filled with a slurry/liquid to remove the soluble impurities and to obtain pure oxygen.

5. The device as claimed in claim 2, wherein the first chamber has a mesh to remove the bigger size particles from the effluent gas.

6. The device as claimed in claim 2, wherein the second chamber is filled with a mixture of slurry to remove soluble gases and to obtain pure oxygen emitted through to an outlet of fourth chamber.

7. The device as claimed in claim 2, wherein the third chamber is filled with a liquid containing crude bio-diesel or bio-Oil along with chemical extract from petro plants.

8. The device as claimed in claim 2, wherein the fourth chamber contains a slurry of lime and sea water for entrapping CO₂, NO₂, SO₂, HCl, such that pure oxygen is emitted through an outlet of the fourth compartment.

9. The device as claimed in claim 2, wherein the liquid/slurry in the fourth chamber absorbs one or more of sulphur gas, NOₓ gas, and mercury gas.

10. The device as claimed in claim 3, wherein, in step ii, the slurry comprises cow dung and sea water.

11. The device as claimed in claim 3, wherein, in step ii, the slurry removes one or more of CO₂, NO₂, SO₂, and HCl gases and high molecular weight polynuclear hydrocarbon particles.

12. The device as claimed in claim 6, wherein the slurry in the second chamber comprises cow dung mixed with sea water.

13. The device as claimed in claim 6, wherein the slurry in the second chamber removes one or more of CO₂, NO₂, SO₂, and HCl gases.
